(19) United States
(12) Patent Application Publication
(10) Pub. No.: US 2019/0069671 A1
(43) Pub. Date: Mar. 7, 2019

(54) MODULAR STORAGE SYSTEM

(71) Applicant: Michael Williams, Zionsville, IN (US)

(72) Inventor: Michael Williams, Zionsville, IN (US)

(21) Appl. No.: 16/121,288

(22) Filed: Sep. 4, 2018

Related U.S. Application Data
(60) Provisional application No. 62/553,367, filed on Sep. 1, 2017.

(51) Int. Cl. A47B 73/00; A47B 81/02; A47F 5/08

(52) U.S. Cl. CPC A47B 73/006; A47J 47/16; A47F 5/0838; A47B 81/02

(57) ABSTRACT

A tool storage system for loading, storing, and transporting tools.

### RELATED APPLICATIONS

The present application claims the benefit of U.S. Provisional Patent Application No. 62/553,367 to Michael Williams entitled “Modular Storage System” and filed on Sep. 1, 2017, which is hereby incorporated by its reference in entirety.

### BACKGROUND AND SUMMARY OF THE DISCLOSURE

The present disclosure relates generally to tools and tool storage.

Almost all occupations require some sort of tool or device to get a job done. When the number of devices needed to accomplish a job outnumbers the number of hands the user has, it is easier for the user to have a means of organizing and transporting the tools of his trade. Whether it is kitchen utensils, woodworking tools, pens, or any other collection of devices, having a means of easily organizing and transporting these devices makes the users life much easier. The present disclosure solves this issue. The present disclosure allows for the easy storage and transport of a number of devices. The present disclosure allows for the user to attach devices to one part of the present disclosure that can easily be transported. A separate part of the present disclosure allows for the easy mounting and storage of the devices.

### BRIEF SUMMARY OF THE DISCLOSURE

In certain aspects, an embodiment of the present disclosure provides a tool storage system that stores tools and other implements. The tool storage system includes a bar, a rail, and at least one hitch affixed to flat surfaces. The bar includes a connection joint inserted into a receiving channel of the rail. The tool storage system further includes a set of utility bags and a set of carabiners

According to another aspect of the present disclosure, a tool storage system is provided that includes a bar further including a support body containing openings on both ends for fasteners. The bar supports tools.

Additional features of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The aforementioned aspects of this disclosure will grow to be appreciated at a greater level once references to the following accompanying illustrations are expounded upon.

FIG. 1 is a perspective view of an embodiment of a storage system including the bar, rail, and the hitch;

FIG. 2 is a side perspective view of the storage system of FIG. 1;

FIG. 3 is a perspective view of one of the hitches of the storage system and rail shown translucent;

FIG. 4 is a side view of the storage system; and

FIG. 5 is a perspective view of the storage system attached to a table.

Equivalent reference components point to corresponding parts throughout the several views. Unless otherwise indicated, the components are shown proportional to each other. Wherein, the illustrations depicted are manifestations of the disclosure, and such illustrations shall in no way be interpreted as limiting the scope of the disclosure.

For the purposes of promoting and understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION

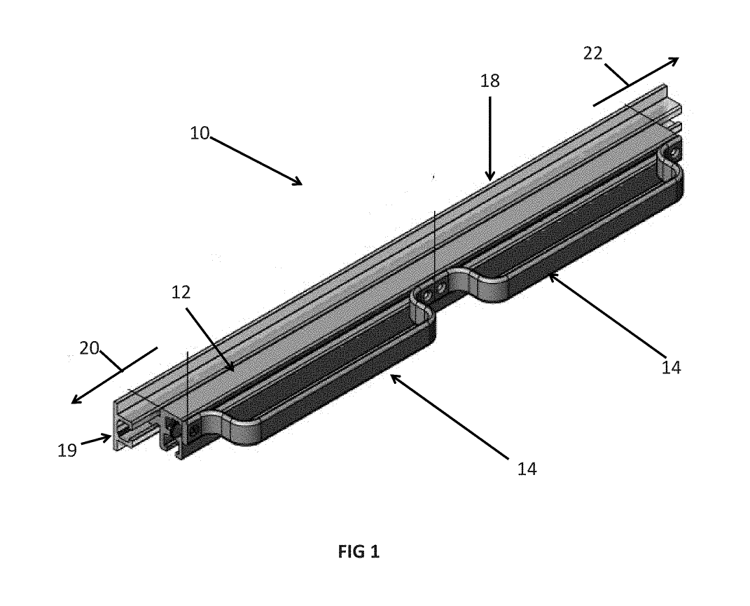

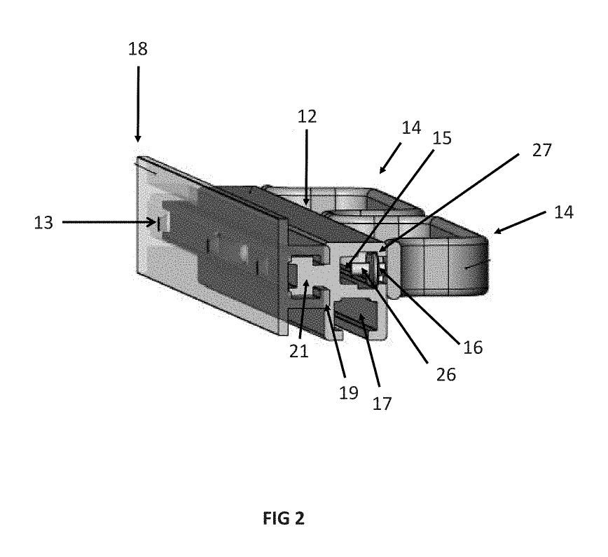

Referring to FIG. 1, an embodiment of a tool storage system 10 is shown. Tool storage system 10 includes a rail 18, a bar 12, a pair of hitches 14. Rail 18 is capable of being mounted to flat surfaces such as a wall, a work bench, etc. Each hitch 14 is coupled to bar 12 by a pair of fasteners 26, see FIG. 2. Tool storage system 10 is preferably made of aluminum, but it can be made of other metal and materials.

Extruded rail 18 includes receiving channel 19 capable of receiving a connection joint 21 of extruded bar 12. Receiving channel 19 runs longitudinally along extruded rail 18 and is opposite an external surface to which extruded rail 18 is attached. In one embodiment, receiving channel 19 is substantially in the shape of a square with an opening on at least one side. Extruded rail 18 includes a plurality of holes 13 to facilitate a connection between extruded rail 18 and a flat surface such as a wall or a work bench with a fastener, such as a wood screw.

Extruded bar 12 includes a first reception channel 15, a second reception channel 17 positioned below first reception channel 15, and a connection joint 21. First reception channel 15 and second reception channel 17 are each substantially in the shape of a square with an opening on at least one side. First reception channel 15 and second reception channel 17 in extruded bar 12 may receive at least one fastener 26 to secure hitches 14 to extruded bar 12 through a substantially rectangular plate 16 abutting against the portion of first reception channel 15 defining the opening. As such, hitches 14 may be coupled to bar 12 as shown in FIG. 1 to extend horizontally or may be coupled to bar 12 to extend vertically. Connection joint 21 is opposite first reception channel 15.

As shown in FIGS. 1 and 2, extruded bar 12 couples with extruded rail 18 via second receiving channel 19 allowing extruded bar 12 to move longitudinally along extruded rail 18 either in a first direction 20 or a second direction 22.

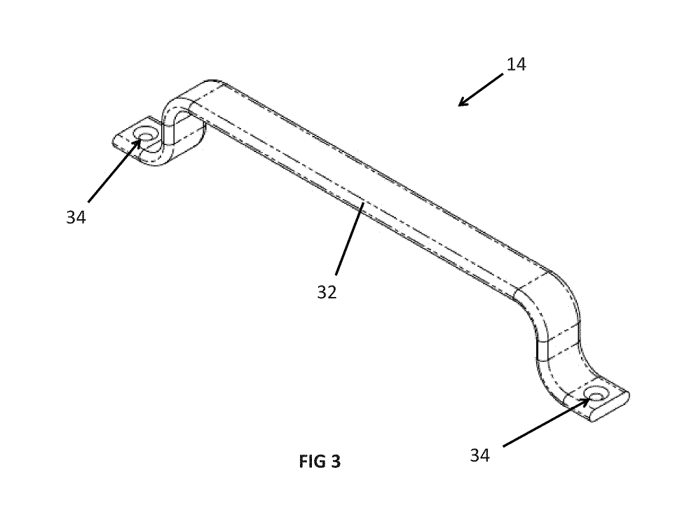

Referring to FIG. 3, hitch 14 is shown. Hitch 14 includes a hanging bar 32 and openings 34. Hanging bar 32 can be directly affixed to a flat surface, such as a wall, work bench, etc. when fasteners are placed into openings 34 and the flat surface or may be secured to bar 12 as shown in FIGS. 1, 2, and 4. Fastener 26 can include screws, bolts, nails, pins, or other fastener embodiments.

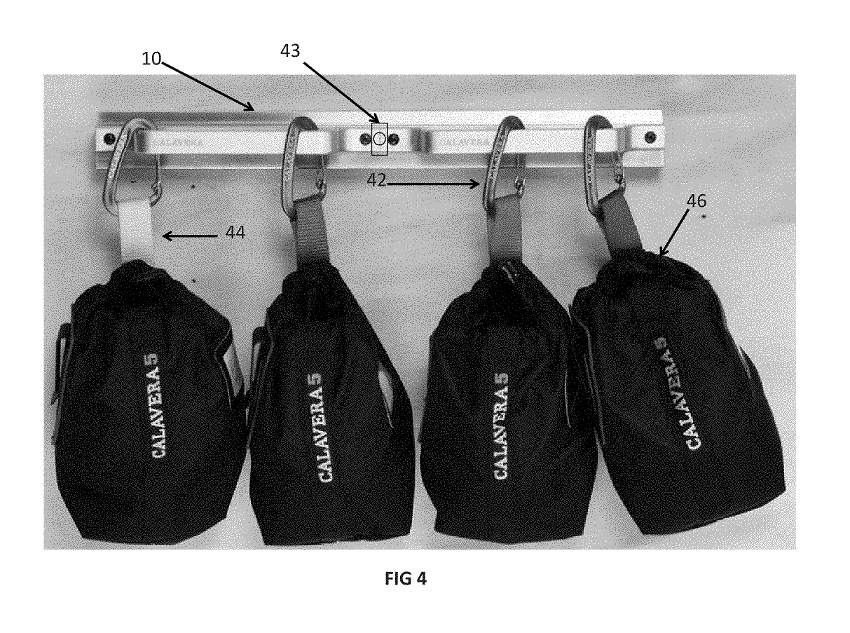

Referring to FIG. 4, tool storage system 10 is shown. Tool storage system 10 further includes a plurality of utility bags 46 and carabiners 42. Each of plurality of utility bags 46 includes a loop 44 to facilitate, through carabiners 42, the coupling and uncoupling of plurality of utility bags 46 to hitch 14. Other embodiments of tool storage system 10 could include other tool receptacles in place of plurality of utility bags 46, such as bins, baskets, shelves, tubs, pockets, or other receptacle containers. Carabiners 42 facilitate the removal of bags 46 from hitches 14.

Tool storage system 10 includes a knob 43 configured to block sliding movement of extruded bar 12 relative to rail 18. Extruded bar 12 includes a threaded hole through which a threaded shank (not shown) of knob 43 extends. When knob 43 is turned clockwise, the shank extends toward rail 18 until contacting rail 18 to block the sliding movement. To allow sliding movement, knob 43 is rotated counterclockwise to back the shank away from rail 18 and unbind bar 12 and rail 18.

Plurality of utility bags 46 may be comprised of a number of materials, such as vinyl, fabric, plastic, polymer, or other materials. Loop 44 facilitating the coupling of plurality of utility bags 46 and hitch rail 14 may be enabled by other coupling mechanisms beyond loop 44 including embedded hooks, open loops, or pins, among others. In the present embodiment, carabiners 42 interlace through both hitch 14 and loop 44, allowing utility bags 46 to suspend from hitch 14 or bar 32 when coupled.

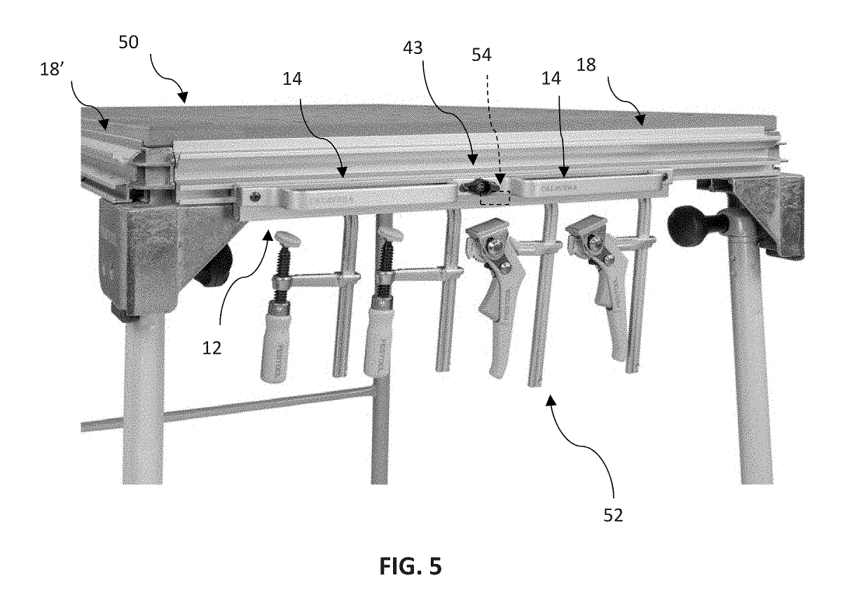

Referring now to FIG. 5, an embodiment of the present disclosure is shown. A rail 18 is coupled to a substantially flat surface 50. A bar 12 is coupled to the rail 18. A hitch 14 is coupled to the bar 12. Rail 18 is capable of being mounted to flat surfaces such as a side of a table, a wall, a work bench, etc. Each hitch 14 is coupled to bar 12 by a pair of fasteners 26, see FIG. 2. The bar 12 is coupled to the rail 18 in a fashion that permits the bar 12 to slide along the rail 18. The present disclosure includes a knob 43 configured to block sliding movement of bar 12 relative to rail 18. The bar 12 includes a threaded hole through which a threaded shank (not shown) of knob 43 extends. When knob 43 is turned, the shank extends toward rail 18 until contacting rail 18 to block the sliding movement. To allow sliding movement, knob 43 is rotated in the opposite direction to back the shank away from rail 18 and unbind bar 12 and rail 18.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertain.

What is claimed is:

1. A tool storage system for a table comprising
a rail configured to be coupled to a table;
a bar slidably coupled to the rail; and
an at least one hitch coupled to the bar.

2. The tool storage system of claim 1, wherein the bar includes a downward-facing channel configured to receive a clamp head.

3. The tool storage system of claim 1, further comprising at least one fastener, wherein the bar includes an outward-facing channel receiving the at least one fastener to couple the hitch to the bar.

4. The tool storage system of claim 3, wherein the bar includes a downward-facing channel.

5. The tool storage system of claim 4, wherein the downward-facing channel is configured to receive the head of a clamp.

6. The tool storage system of claim 5, wherein the downward-facing channel is substantially perpendicular to the outward-facing channel.

7. The tool storage system of claim 1, wherein the rail includes an outward-facing channel configured to receive the bar.

8. The tool storage system of claim 7, wherein the bar includes a downward-facing channel.

9. The tool storage system of claim 8, wherein the downward-facing channel is configured to receive the head of a clamp.

10. The tool storage system of claim 1, wherein the bar includes a downward-facing channel, the bar includes an outward-facing channel, the rail includes an outward-facing channel, and the downward-facing channel, the outward-facing channel of the bar, and the outward-facing channel of the rail have substantially the same profile.

11. A tool storage system comprising
a first substantially flat surface;
a first rail coupled to the first substantially flat surface;
a second substantially flat surface;
a second rail coupled to the second substantially flat surface;
a bar coupled to the first rail and configured to be coupled to the second rail; and
a hitch coupled to the bar.

12. The tool storage system of claim 11, wherein the first rail includes an outward-facing channel configured to receive the bar and the second includes an outward-facing configured to receive the bar.

13. The tool storage system of claim 12, wherein the outward-facing bar of the first rail and the outward-facing bar of the second rail have substantially the same profile.

14. A method for moving tool components comprising the steps of
providing a tool storage system including a first rail, a bar slidably coupled to the first rail, at least one hitch coupled to the bar, and a second rail,
decoupling the bar from the first rail by sliding the bar relative to the first rail,
moving the bar to the second rail, and
coupling the bar to the second rail by sliding the bar relative to the second rail.

15. The method of claim 14, further comprising the steps of
providing an at least one storage receptacle configured to hold tools;
coupling the at least one storage receptacle to the hitch.

16. The method of claim 14, further comprising the steps of
providing an at least one fastener, and
adjusting the fastener to allow or disallow sliding the bar relative to the first rails.
